(19) United States
(12) Patent Application Publication
(10) Pub. No.: US 2021/0078505 A1
(43) Pub. Date: Mar. 18, 2021

(54) SWIVELING RACK FOR LAWN EQUIPMENT

(71) Applicant: Roy Kenneth Reinhardt, Brandon, MS (US)

(72) Inventor: Roy Kenneth Reinhardt, Brandon, MS (US)

(21) Appl. No.: 17/025,433

(22) Filed: Sep. 18, 2020

Related U.S. Application Data
(60) Provisional application No. 62/902,279, filed on Sep. 18, 2019.

(51) Int. Cl. B60R 11/06; A47B 81/00; A47B 46/00

(52) U.S. Cl. CPC B60R 11/06; B60R 2011/0075; A47B 46/00; A47B 81/00

(57) ABSTRACT

A rack for a backpack-type lawn tool is provided, comprising a base member having an upper side and lower side, wherein the lower side includes a swivel device attached to the lower side; a mounting member attached to the swivel device, wherein the mounting member is adapted to mount to a frame of a vehicle or stationary object at a height which is near the height of the tool when worn on the user, and wherein the base is rotatable relative to the frame between a storage position and an operation position; and a container adapted to retain a backpack-type lawn tool, wherein the container is attached to the base member and includes a floor and at least one side member extending upwardly from the floor. The rack may further include a locking device disposed between the base member and the frame which restricts or permits rotation of the base member relative to the frame.

### CROSS REFERENCE TO RELATED APPLICATIONS

The present application derives priority from U.S. Provisional Patent Application Ser. No. 62/902,279, filed Sep. 18, 2019, the entirety of which is incorporated herein by reference.

### BACKGROUND OF THE INVENTION

### 1. Field of the Invention

The present invention relates generally to racks used to assist a user with loading and unloading a backpack-style lawn tool, such as a leaf blower or sprayer, used for lawn maintenance, and more particularly to such racks mounted on vehicles and which enable the rack to swivel between multiple positions.

### 2. Description of Related Art

Backpack-type lawn tools, such as commercial-grade leaf blowers and sprayers (hereinafter “blowers”), are typically heavy and bulky, and it can be difficult to manipulate the tool on and off the user. For example, in many instances, the blower rests on the floor of a trailer or other vehicle, and when the user is ready to work, the blower must be lifted by its straps which are placed over the shoulders, all the while struggling with the weight of the blower before it is secured to the user. Similarly, when the work is done, the reverse process of removing the blower from the user is likewise a challenge due the weight and bulk of the blower.

Over the years, a number of inventions have been devised to solve various problems with the storage, transport, and wearing of backpack-type blowers. First, devices or racks that hold the blower for storage are known, such as U.S. Pat. No. 6,536,610 to Taylor; U.S. Pat. No. 6,302,280 to Bermes; U.S. Pat. No. 7,849,557 to Bellis; and U.S. Patent Publication No. 2018/0328083 to Sargent. All of these devices are capable of holding the blower for storage and transport, and for enabling the user to mount and dismount the blower more easily on the user, because the racks are at a height that is near the operational wearing height of the blower.

However, despite the advantages of those devices, there are notable deficiencies. First, none of the racks in the cited prior art disclose the use of a horizontal swivel for allowing rotation of the rack between a storage position and an operational position. Second, none of those devices disclose a storage container that includes contiguous side walls that can define a volume to hold the blower and which can also be used to store other accompanying items or tools, or even use the container floor surface as a repair site. Finally, all of those devices appear to require tall vertically oriented support members as the “backbone” of the rack, along with clips, hooks, and brackets. In those devices, the blower is positioned against the support member with the blower straps toward the support member. So, regardless of how the user approaches the blower to wear it, the blower must either be removed and turned around before it can be worn, or the user must deal with an intervening support member when putting on the straps. There is a need for a support rack which avoids these drawbacks of the prior art. These and other advantages of the present invention are explained in more detail in the following specification and drawings.

### SUMMARY OF THE INVENTION

In summary, the present invention is a rack for a backpack-type lawn tool, comprising a base member having an upper side and lower side, wherein the lower side includes a swivel device attached to the lower side; a mounting member attached to the swivel device, wherein the mounting member is adapted to mount to a frame of a vehicle or stationary object, and wherein the base is rotatable relative to the frame; and a container adapted to retain a backpack-type lawn tool, wherein the container is attached to the base member and includes a floor and at least one side member extending upwardly from the floor.

Preferably, the rack further includes a locking device operatively disposed between the base member and the frame which restricts or permits rotation of the base member relative to the frame.

The rack may further include a securing device attached to the container to secure the tool to the container.

The container may be sized and shaped to substantially conform to a size and shape of the tool.

Preferably, the container is rotatable between a storage position and an operational position, wherein the locking device is engaged when the container is in a storage position and disengaged when the container is in an operational position. The operational position is preferably at least 90 degrees from the storage position.

More preferably, the container has at least four contiguous side members to define a storage volume for the tool. The side members may include a front side member corresponding to a front portion of the tool, a rear side member corresponding to a rear portion of the tool, and a left side member and a right side member corresponding to a left side and a right side of the tool. The floor of the container includes one or more drainage holes formed therein.

The locking device may be resiliently biased to an engaged position.

The rack may be mounted to the frame at a height which is near the height of the tool when worn on the user.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1A illustrates a perspective view of a swiveling rack for lawn tools in a preferred embodiment of the present invention, shown attached to a trailer frame and containing a backpack-type leaf blower in a stored configuration.

FIG. 1B illustrates the rack of FIG. 1 without the blower stored within the rack.

FIG. 2 illustrates a top view of the rack of FIGS. 1A and 1B.

FIG. 3 illustrates a side view of the rack of FIGS. 1A and 1B.

FIG. 4 illustrates a cross-sectional view of the rack of FIG. 1 with details of the swivel.

FIG. 5A illustrates a top perspective view of the container according the one embodiment of the present invention.

FIG. 5B illustrates a top view of the container according the one embodiment of the present invention.

FIG. 5C illustrates a side view of the container according the one embodiment of the present invention.

FIG. 5D illustrates a front view of the container according the one embodiment of the present invention.

FIG. 5E illustrates a top perspective view of the container according the one embodiment of the present invention, wherein the closure 16 is in an open position.

### DETAILED DESCRIPTION OF THE INVENTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed. In addition, a specific scale of operation is described as the current illustrative embodiment; however, the scale can be increased or decreased by simply adjusting the size of the various parts of the apparatus as will be apparent to one of skill in the art, and no limitation of the scale of operation is intended by this specification.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “having,” “containing,” “characterized by,” and grammatical equivalents thereof are inclusive or open-ended terms that do not exclude additional, unrecited elements or method steps.

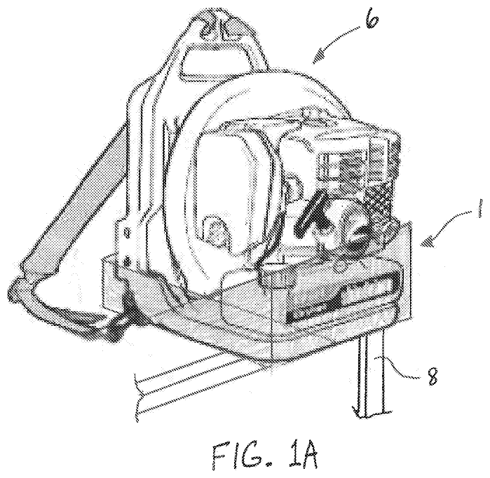

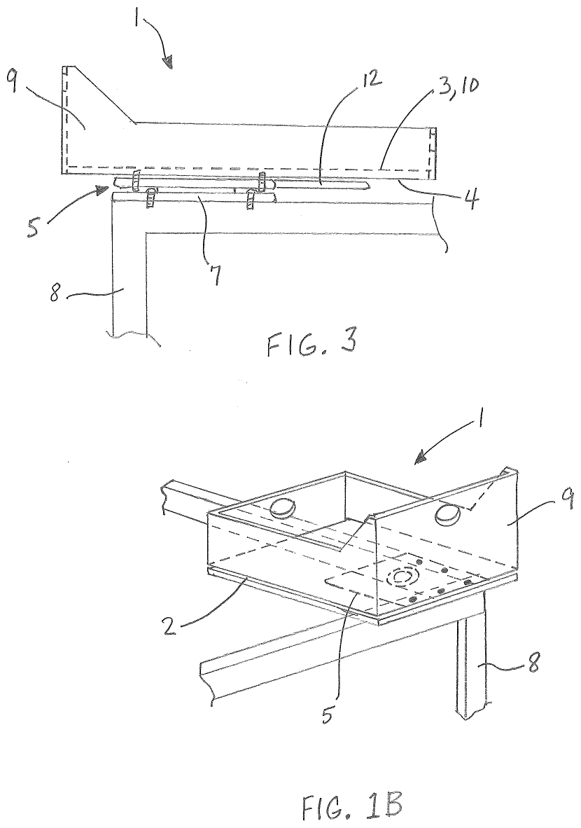

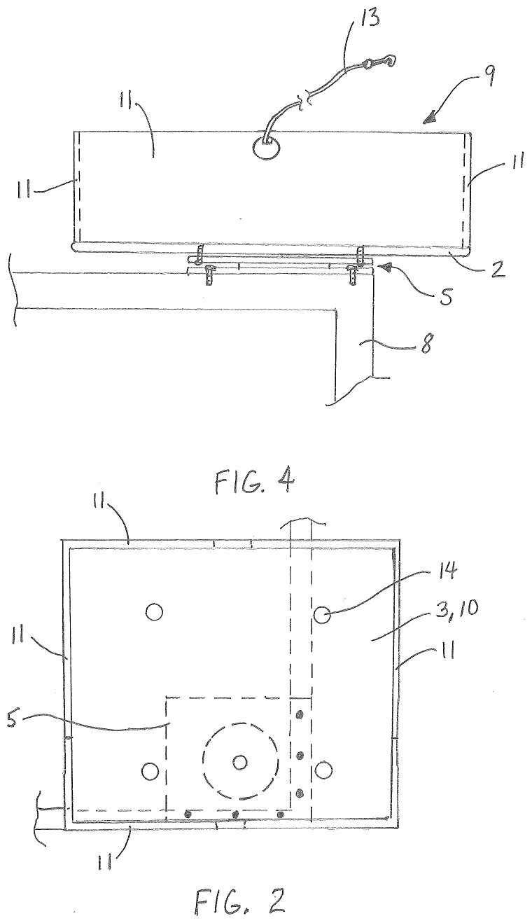

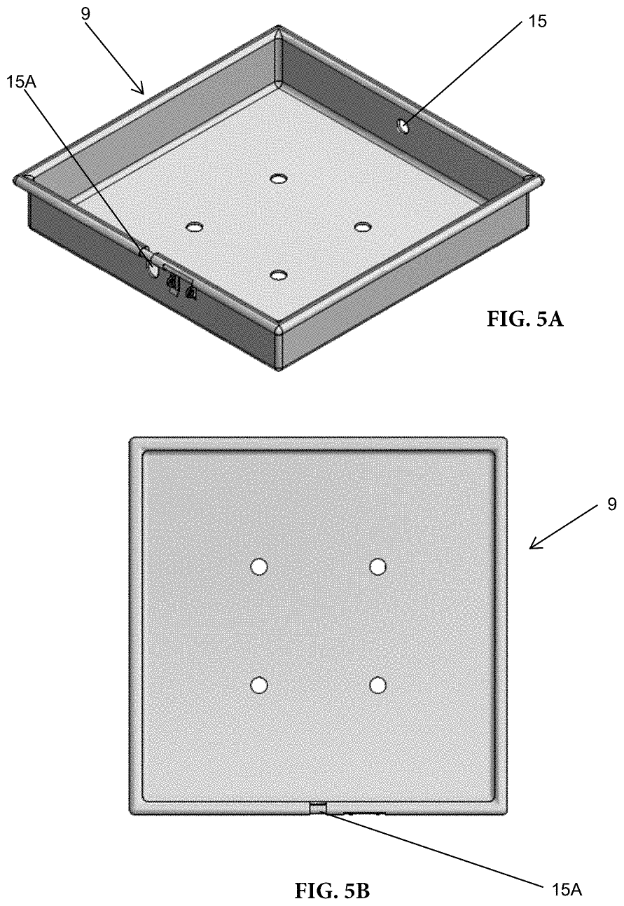

With reference to a preferred embodiment of the invention shown in FIGS. 1-5, a rack for a backpack-type lawn tool 1, such as a commercial leaf blower or sprayer is described. For the purposes of this specification and the claims, the term “blower” or “tool” will be used for convenience, although it should be understood that the present invention can be used for any type of heavy or bulky tool that is worn by a user.

As shown in FIG. 1A and FIG. 1B, the rack 1 generally comprises a base member 2 having an upper side 3 and lower side 4, wherein the lower side 4 includes a swivel device 5 attached to the lower side 4. The rack 1 is shown in a transparent mode to illustrate the blower 6 positioned within the rack 1. A mounting member 7 is attached to the swivel device 5, wherein the mounting member 7 is adapted to mount to a frame 8 of a vehicle or stationary object, such as a tool trailer. The base member 2 is rotatable relative to the frame 8. A container 9 is adapted to retain the backpack-type lawn tool 6, wherein the container 9 is attached to the base member 2 and includes a floor 10 and at least one side member 11 extending upwardly from the floor 10.

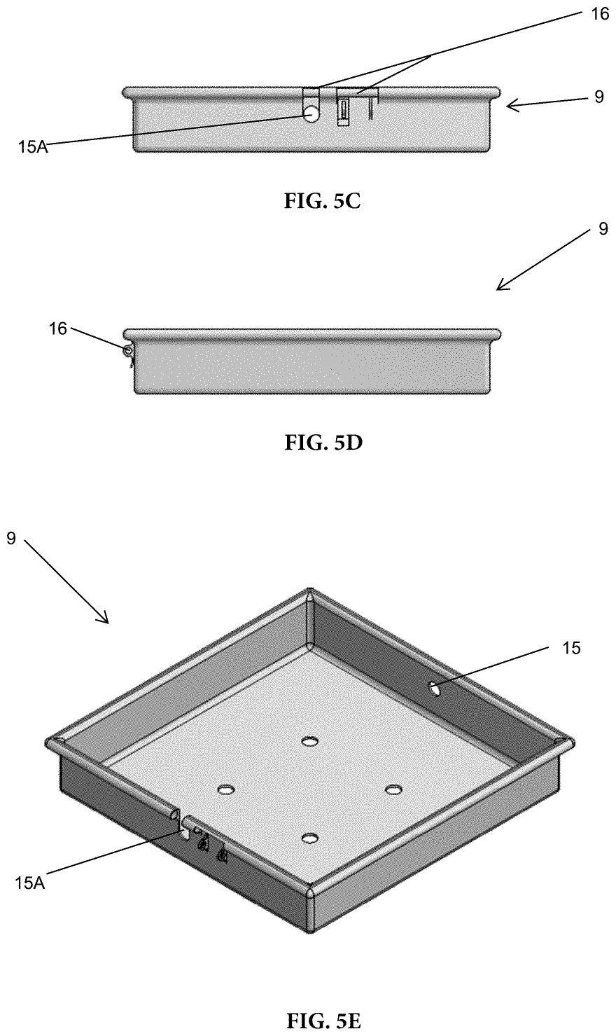

In a preferred embodiment, the rack 1 further includes a locking device 12 operatively disposed on the swivel device 5 between the base member 2 and the frame 8 which restricts or permits rotation of the base member 2 relative to the frame 8. The locking device 12 may be resiliently biased to an engaged position. Although various swivel devices 5 can be used to achieve similar functionality and advantages, one nonlimiting example of a swivel device 5 is the “Locking Boat Seat Swivel—12 Position” manufactured by Wise Seats, which is often used with boat seats. The rack 1 further includes a securing device 13 attached to the container 9 to secure the tool 6 to the container 9, such as by passing a cable attached on one of the side walls 11 through the blower 6 (such as under the handle) and then attached to an opposite side wall 11. With reference to FIGS. 5A-5E, in preferred embodiments, opposing side walls 11 of container 9 (such as a left side member and a right side member, described below) have through-holes 15 therein to accommodate the primary diameter of a securing device 13 and secure each of the larger-diameter ends of securing device 13 on the outside of opposing sides of container 9 to allow securing device 13 (which may be made of, e.g., an elastic material, a performance fabric material, or a metal or coated metal chain) to stretch or be tensioned across the top of (or around the sides of) tool 6. One such through-hole 15A can be open along the top edge of the respective side wall 11 and closable along an upper edge thereof to allow insertion and removal of one end of securing device 13 to allow for such tensioning and/or application or removal of the securing device 13 from around tool 6. Such closure 16 could be in the form of a rotating latch (e.g., hook and loop) or a slide latch wherein the sliding bolt portion may be couched within an interior of side wall 11 when through-hole 15A is open, as shown in FIG. 5E.

The container 9 is sized and shaped to substantially conform to a size and shape of the tool 6. Preferably, the container 9 is rotatable between a storage position and an operational position, wherein the locking device 12 is engaged when the container 9 is in a storage position and disengaged when the container 9 is in an operational position. The operational position is at least 90 degrees from the storage position, although a more preferred range is about 180 degrees.

The container 9 preferably has four contiguous side members 11 to define a storage volume for the tool 6. The side members 11 include a front side member corresponding to a front portion of the tool, a rear side member corresponding to a rear portion of the tool, and a left side member and a right side member corresponding to a left side and a right side of the tool, respectively. In some preferred embodiments, shown for example in FIG. 1B, one of the side members 11 has a greater height than the other sides. In other preferred embodiments, each of the side members has a similar or the same height. Side members 11 may also have additional features such as a rolled or beaded top edge, for example to protect the surface of tool 6 as it is lifted in and out of container 9. The floor 10 of the container 9 may include one or more drainage holes 14 formed therein, and a rubberized mat or surface may also added to the floor 10.

When the rack 1 is attached to an object, such as a stationary table or a vehicle (such as a trailer frame 8), the rack 1 is preferably mounted to the frame 8 at a height which is near the height of the tool when worn on the user.

Thus, the tool 6, such as a blower, is stored in the rack container with the shoulder straps facing outward toward the user once the rack is placed in its operational position, and the user merely has to place his or her arms through the straps with no intervening support member. In this way, because there is no requirement for the support members utilized by the prior art, the present invention reduces space requirements and clutter, promotes faster mounting and dismounting of the tool 6, and minimizes costs.

As explained earlier herein, the use of a horizontal swivel device 5 between a storage position and an operational position is a significant advantage over all of the known prior art. Also, the container 9 having a floor 10 and contiguous side walls 11 that can hold the blower and other useful items is another important distinction. Moreover, eliminating the use of vertical support members resolves many of the issues that users have with prior art racks, because: (1) the user is free to mount the blower without any obstructions, (2) the user doesn't have to remove the blower from a vertical rack and turn it around because it can be worn, and (3) mounting and dismounting of the blower is a much more convenient and faster procedure for users who must do this many times during the work day.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only, and the scope of the present invention is to be limited only by the following claims.

The invention claimed is:

1. A rack for a backpack-type lawn tool, comprising:
a base member having an upper side and lower side, wherein the lower side includes a swivel device attached to the lower side;
a mounting member attached to the swivel device, wherein the mounting member is adapted to mount to a frame of a vehicle or stationary object, and wherein the base is rotatable relative to the frame; and
a container adapted to retain a backpack-type lawn tool, wherein the container is attached to the base member and includes a floor and at least one side member extending upwardly from the floor.

2. The rack of claim 1, further including a locking device operatively disposed between the base member and the frame which restricts or permits rotation of the base member relative to the frame.

3. The rack of claim 1, further including a securing device attached to the container to secure the tool to the container.

4. The rack of claim 1, wherein the container is sized and shaped to substantially conform to a size and shape of the tool.

5. The rack of claim 1, wherein the container is rotatable between a storage position and an operational position, and further including a locking device operatively disposed between the base member and the frame, wherein the locking device is engaged when the container is in a storage position and disengaged when the container is in an operational position.

6. The rack of claim 5, wherein the operational position is at least 90 degrees from the storage position.

7. The rack of claim 1, wherein the container has at least four contiguous side members to define a storage volume for the tool.

8. The rack of claim 7, wherein the side members include a front side member corresponding to a front portion of the tool, a rear side member corresponding to a rear portion of the tool, and a left side member and a right side member corresponding to a left side and a right side of the tool.

9. The rack of claim 1, wherein the floor of the container includes one or more drainage holes formed therein.

10. The rack of claim 2, wherein the locking device is resiliently biased to an engaged position.

11. The rack of claim 5, wherein the locking device is resiliently biased to an engaged position.

12. The rack of claim 1, wherein the rack is mounted to the frame at a height which is near the height of the tool when worn on the user.
